(19) United States
(12) Patent Application Publication
(10) Pub. No.: US 2004/0134313 A1
(43) Pub. Date: Jul. 15, 2004

(54) Ratchet wrench

(76) Inventor: Lin-Lang Liu, Taipei (TW)

Correspondence Address: Lin-Lang Liu, PO Box 82-144, TAIPEI, TW

(21) Appl. No.: 10/338,868

(22) Filed: Jan. 9, 2003

(51) Int. Cl. B25B 13/46

(52) U.S. Cl. 81/63.2

(57) ABSTRACT

A ratchet wrench is disclosed. The ratchet wrench is characterized in that the head portion has a tool connector cavity, and has a ratchet cavity adjacent to one side of the handle for communication with the tool connector, the ratchet block is positioned within the ratchet block cavity which can automatically move forward, the top face of the head portion corresponding to the top edge of the ratchet cavity is a notch for engaging with a covering plate; the middle section of the external edge is a tool connector is formed into a position-limiting circular slot, and the ratchet block having a ratchet wall with ratchet teeth is provided with position-limiting block which can correspondingly engage with the circular slot, and the top face of the ratchet block is protruded with a trigger rod passed through the covering plate, and the center of the covering plate is a corresponding T-shaped trigger recess, thereby a ratchet wrench is obtained. When the ratchet block urges the tool connector, the urging force of the position-limiting protruded block is increased and the anti-torsional force is improved and the ratchet block moves backward facilitating the replacement of tool connector.

### BACKGROUND OF THE INVENTION

(a) Technical Field of the Invention

The present invention relates to a ratchet wrench, and in particular, to a wrench employing ratchet block to change the direction of rotation of a tool.

(b) Description of the Prior Art

FIGS. 1 and 2 show a conventional ratchet wrench having a handle 10 with a head portion 11. The head portion is provided with a tool connector cavity 12, and the head portion 11 and the handle 10 are in communication with the cavity 12 of the tool connector 20 and between the head portion 11 and the handle 10, a ratchet block cavity 13 and the trigger block cavity 14 in communication with the tool connector cavity 12.

The ratchet block cavity 13 and the trigger block cavity 14 are adapted for the ratchet block 22 and the trigger block 15. The bottom face of the trigger block cavity 14 is a pivotal slot 140. The wall face of the trigger block cavity 14 is a cavity hole 141 extended toward the handle 10. The cavity hole 141 can adapt a top peg 160 and an elastic element 161. The wall face of the trigger block 15 is formed into a trigger arch edge 151 for positioning of the trigger block 15. The bottom face of the trigger block 15 is a pivotal block 150 corresponding to a pivotal slot 140.

The extended edge of the trigger block 15 is provided with a cavity hole 152 containing a top peg 170 for supporting the ratchet block 22 and an elastic element 171. The wall face corresponding to the ratchet block 22 is a positioning arch edge 23, and the external edge of the tool connector 20 is formed into a ratchet teeth 21 corresponding to the ratchet block 22, and the ratchet block 22 is used for the positioning of the rotation of the tool connector 20. The top edge of the recess 12 is provided with a position-limiting structure 25 for locking the tool connector 20 within the head portion 11.

The drawbacks of the conventional ratchet wrench are as follows:

The components for forming a ratchet wrench are too many, and therefore the cost of production is high;

The scope of tolerance is small and therefore, a small error will cause an ineffective operation of the ratchet wrench; and

The anti-torsional force is insufficient.

The tool connector cannot be replaced due to the use of the position-limiting structure 25 to lock the tool connector 20 within the head portion 11.

Taiwanese Patent Publication No. 382300 discloses a ratchet wrench having a single-sided engagement to achieve the replacement of the tool connector. The disadvantage of this conventional ratchet wrench is that only a fastener is used to restrict the position and if the fastener is knocked or touched, the tool connector will be disengaged and therefore, it is inconvenient with respect to application.

Accordingly, it is an object of the present invention to provide a ratchet wrench to mitigate the above drawbacks.

### SUMMARY OF THE INVENTION

Accordingly, it is an object of the present invention to provide a ratchet wrench which improves the anti-torsional force of the ratchet wrench.

Another object of the present invention is to provide a ratchet wrench having a handle end portion forming into a head portion containing a tool connector and a ratchet block, characterized in that the head portion has a tool connector cavity, and has a ratchet cavity adjacent to one side of the handle for communication with the tool connector, the ratchet block is positioned within the ratchet block cavity which can automatically move forward, the top face of the head portion corresponding to the top edge of the ratchet cavity is a notch for engaging with a covering plate; the middle section of the external edge is a tool connector is formed into a position-limiting circular slot, and the ratchet block having a ratchet wall with ratchet teeth is provided with position-limiting block which can correspondingly engage with the circular slot, and the top face of the ratchet block is protruded with a trigger rod passed through the covering plate, and the center of the covering plate is a corresponding T-shaped trigger recess, thereby a ratchet wrench is obtained.

Yet a further object of the present invention is to provide a ratchet wrench having a handle end portion forming into a head portion containing a tool connector and a ratchet block, characterized in that the head portion has a tool connector cavity, and has a ratchet cavity adjacent to one side of the handle for communication with the tool connector, the ratchet block is positioned within the ratchet block cavity which can automatically move forward, the top face of the head portion corresponding to the top edge of the ratchet cavity is a notch for engaging with a covering plate, wherein the external edge of the tool connector is a series of ratchet teeth and the ratchet block is engageable with the tool connector, and the top face of the ratchet block is protruded with a trigger rod passed through the covering plate, and the center of the covering plate is a corresponding traverse trigger slot, thereby a ratchet wrench is obtained.

Other objects, and advantages of the present invention can be more fully understood by reading the following detailed description of the preferred embodiment, with reference to the accompanying.

### BRIEF DESCRIPTION OF THE DRAWINGS

FIG. 1 is a perspective exploded view of a conventional ratchet wrench.

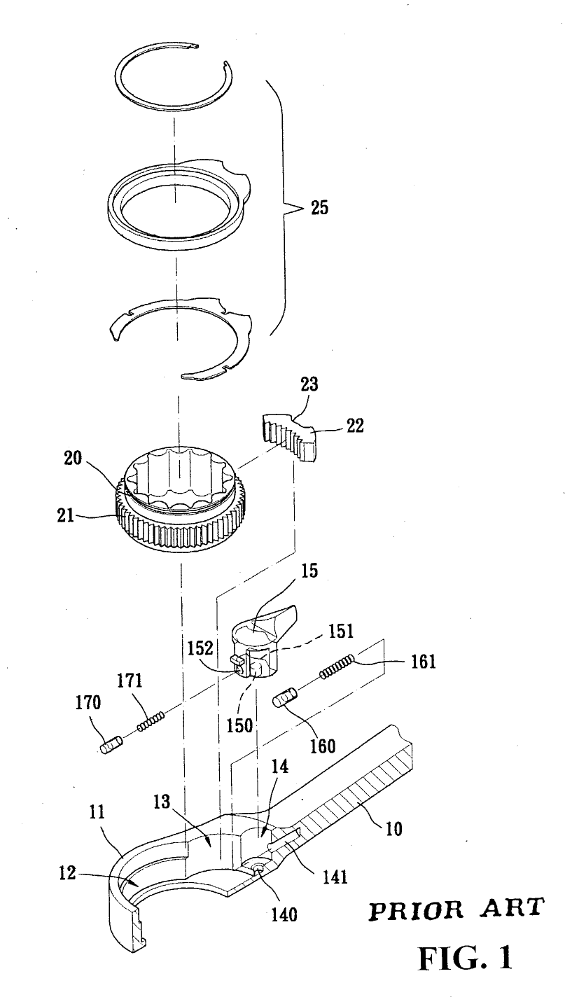

FIG. 2 is a plan view of a conventional ratchet wrench.

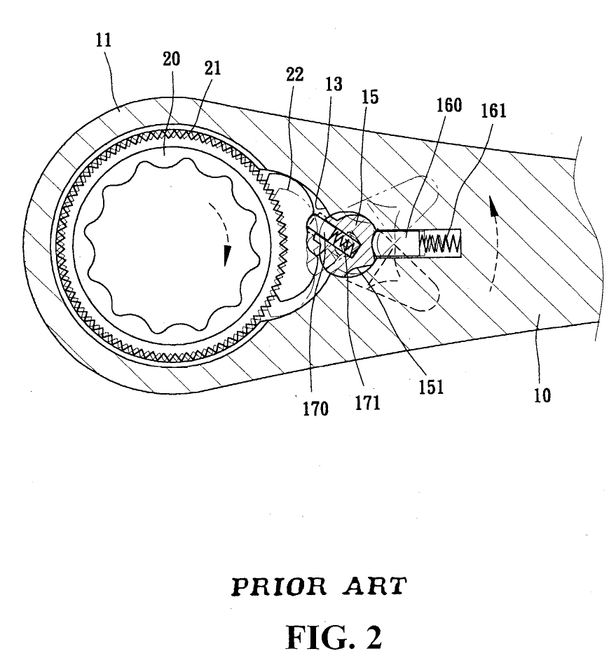

FIG. 3 is a perspective exploded view of the ratchet wrench of the present invention.

FIG. 4 is a schematic view showing the first action of the present invention.

FIG. 5 is a schematic view showing the second action of the present invention.

FIG. 6 is a perspective exploded view of another preferred embodiment.

FIG. 7 is a perspective exploded view of a further preferred embodiment in accordance with the present invention.

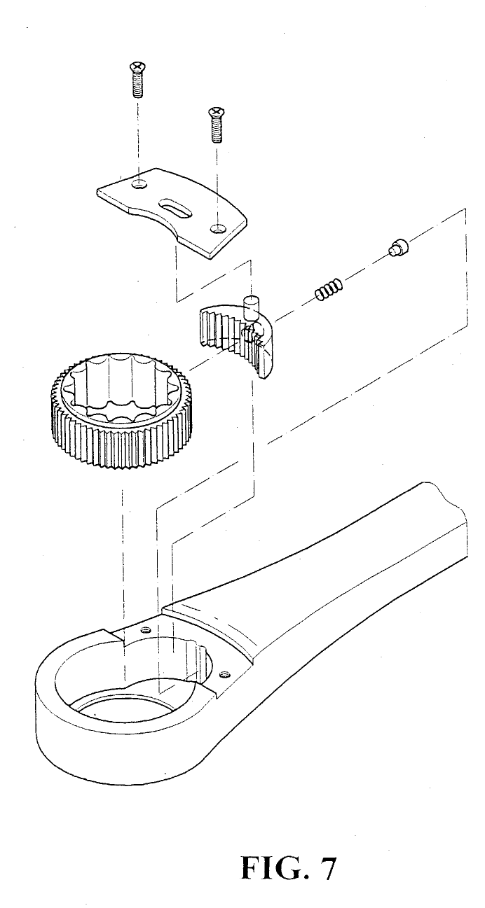

### DETAILED DESCRIPTION OF THE PREFERRED EMBODIMENT

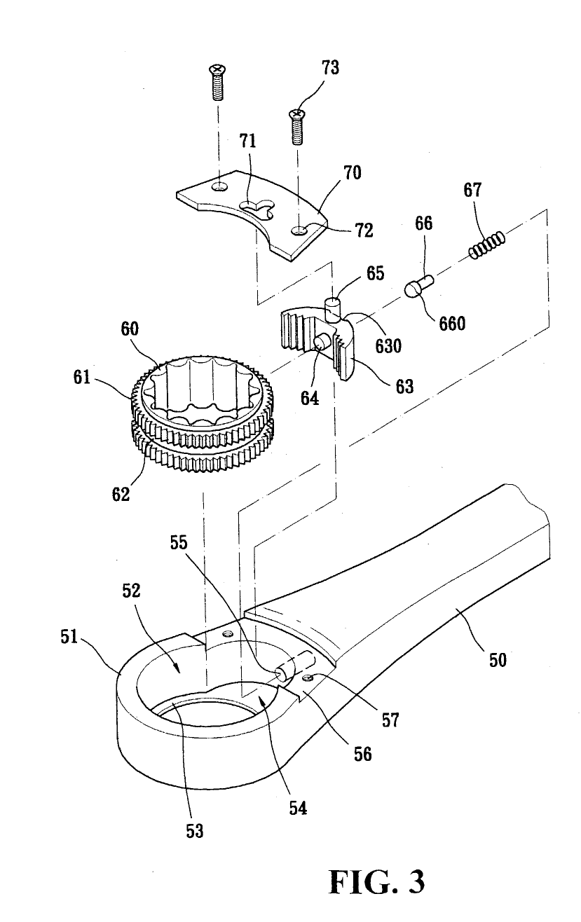

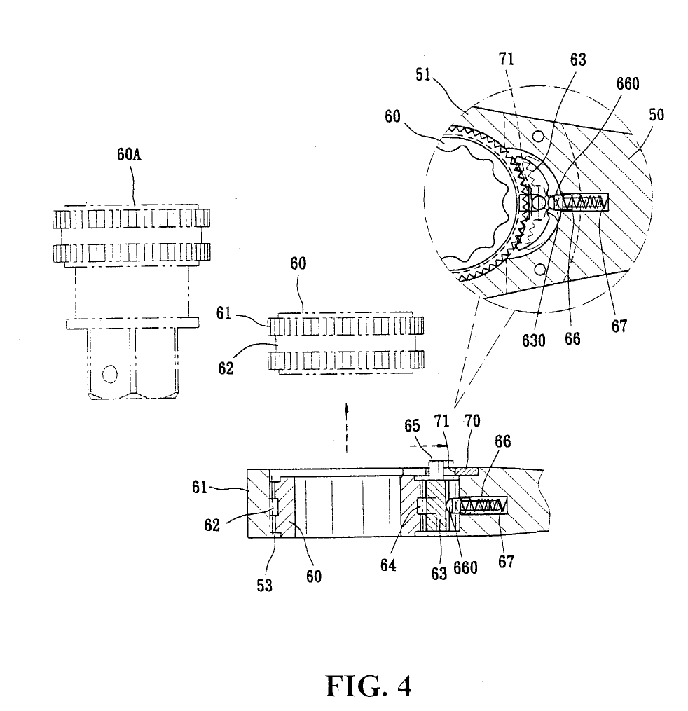

Referring to FIGS. 3 and 4, there is shown a ratchet wrench, in accordance with the present invention, having a handle 50 with an end portion being formed into a large head portion 51.

The head portion 51 can contain a tool connector 60 and a ratchet block 63, and the ratchet block 63 is used to control the empty rotation and direction of the position of the tool connector 60.

The head portion has a tool connector cavity 12, and has a ratchet cavity adjacent to one side of the handle for communication with the tool connector, the ratchet block is positioned within the ratchet block cavity 13 which can automatically move forward, the top face of the head portion corresponding to the top edge of the ratchet cavity is a notch for engaging with a covering plate;

The bottom edge of the tool connector cavity 12 is a protruded urging circular plate for urging with the tool connector.

The top face of the two sides of the notch is provided with a screw hole, and the covering plate is correspondingly provided with through hole and the covering plate is locked to the head portion with bolts.

The middle section of the external edge of the tool connector is a position-limiting protruded ring and the ratchet block is formed into a corresponding position-limiting recess.

The tool connector is either a sleeve or protruded pillar type.

As shown in FIG. 4, when the tool connector 60, 60A is to be replaced, the trigger rod 65 is pushed to the back of the trigger slot 71 of the covering plate 70 and the ratchet block 63 will move simultaneously backward, and the position-limiting protruded block 64 of the ratchet block 63 disengages from the position-limiting circular slot 62 of the tool connector, and therefore the tool connector 60 is withdrawn and a new tool connector 60A is replaced. Finally, the trigger rod 65 is released and the ratchet block 63 will be restored to its original position by the restoration spring 67 and the top support rod 66 such that the position-limiting protruded block 64 is engaged again with the circular slot 62 and the tool connector 60A is positioned. Thus, the tool connector 60A, 60 can be replaced.

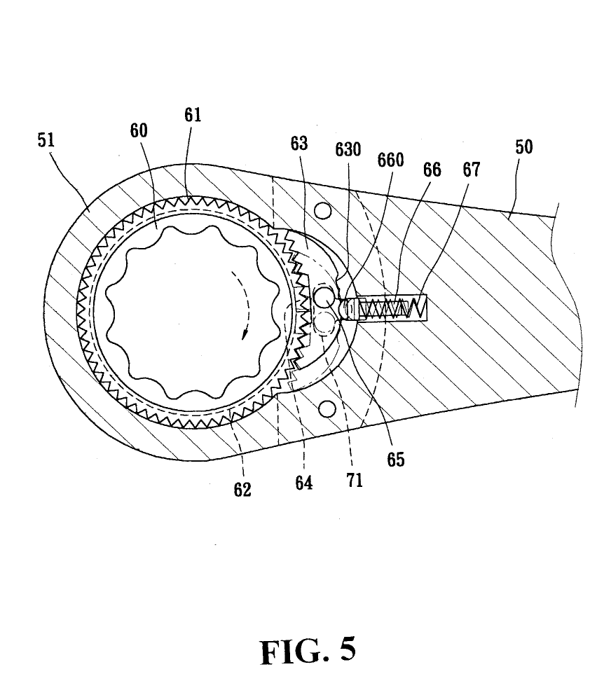

As shown in FIG. 5, if the tool connector 60 is deadly engaged with the ratchet block 63, the anti-torque is absorbed by the protruded block 64 and the circular slot 62 without the ratchet gear 61. Therefore, the gears 61 will not be damaged and the longevity of the wrench is extended.

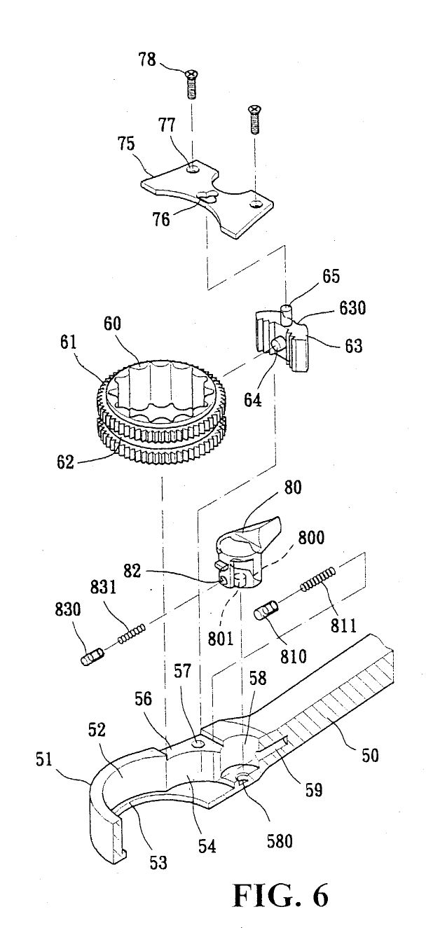

FIG. 6 is another preferred embodiment wherein the rear of the ratchet block cavity 54 is a trigger block 58 having a trigger block 80, and the center of the bottom face is a pivotal slot 580. The head portion 51 is provided with a cavity hole 59, and the rear edge of the trigger block is formed into a triggered positioned arch edge 800 for the positioning of the top peg 810 and the elastic element 811. The bottom face of the trigger block 80 is a pivotal block 801 which can be mounted within the pivotal slot 580. The front edge of the ratchet block 63 is a recess 82 having a top peg 830 and an elastic element 831. The top peg 830 can urge the position arch edge 630 and a covering plate 75 can be mounted the ratchet block 63 and the trigger block 80 is mounted within the head portion 51, and the through hole 77 and the screw bolt 78 are used to lock at the head portion. The top face is provided with a T-shaped trigger slot, thereby the trigger block 80 is used to trigger the ratchet block so as to control the direction of the rotation of the tool connector 60 and is directly triggering downward the trigger rod 65 of the ratchet block 65. Thus, the replacement of the tool connector 60, 60A is achieved.

The advantages of the ratchet wrench of the present invention are as follows:

Low cost of production

Due to the fact that the components of the ratchet wrench are simple and the yield of production is high. Therefore, the cost of production of the ratchet wrench is low.

Actuation of the ratchet wrench is accurate. When the ratchet wrench is applied onto a tool, in appropriate rotation of the wrench will not occur.

While the invention has been described with respect to preferred embodiments, it will be clear to those skilled in the art that modifications and improvements may be made to the invention without departing from the spirit and scope of the invention. Therefore, the invention is not to be limited by the specific illustrative embodiment, but only by the scope of the appended claims.

I claim:

1. A ratchet wrench having a handle end portion forming into a head portion containing a tool connector and a ratchet block, characterized in that the head portion has a tool connector cavity, and has a ratchet cavity adjacent to one side of the handle for communication with the tool connector, the ratchet block is positioned within the ratchet block cavity which can automatically move forward, the top face of the head portion corresponding to the top edge of the ratchet cavity is a notch for engaging with a covering plate; the middle section of the external edge is a tool connector is formed into a position-limiting circular slot, and the ratchet block having a ratchet wall with ratchet teeth is provided with position-limiting block which can correspondingly engage with the circular slot, and the top face of the ratchet block is protruded with a trigger rod passed through the covering plate, and the center of the covering plate is a corresponding T-shaped trigger recess, thereby a ratchet wrench is obtained.

2. The ratchet wrench of claim 1, wherein the bottom edge of the tool connector cavity is a protruded urging circular plate for urging with the tool connector.

3. The ratchet wrench of claim 1 or 2, wherein the top face of the two sides of the notch is provided with a screw hole, and the covering plate is correspondingly provided with through hole and the covering plate is locked to the head portion with bolts.

4. The ratchet wrench of claim 1, wherein the middle section of the external edge of the tool connector is a position-limiting protruded ring and the ratchet block is formed into a corresponding position-limiting recess.

5. The ratchet wrench of claim 1 or 4, wherein the tool connector is either a sleeve or protruded pillar type.

6. The ratchet wrench of claim 1, wherein the wall face of the ratchet block cavity is a cavity hole containing a restoration spring and a top support rod, thereby the ratchet block trigger rod is used to trigger the ratchet block to control the direction of rotation of the tool connector.

7. The ratchet wrench of claim 1, wherein the rear section of the ratchet block cavity is provided with a trigger block cavity for pivotal mounting with the trigger block, and the rear wall face of the trigger block cavity is provided with a cavity hole for a top peg and an elastic element, and the front edge of the ratchet block corresponding to the trigger block is formed into a recess hole for a top peg and an elastic element, thereby the trigger block is used to trigger the ratchet block to control the direction of rotation of the tool connector.

8. The ratchet wrench of claim 7, wherein the center at the bottom face of the trigger block cavity is a pivotal slot and the bottom face of the trigger block is protruded with a pivotal block which can be pivotally mounted within the pivotal slot, and the trigger block is pivotally mounted at the head portion.

9. A ratchet wrench having a handle end portion forming into a head portion containing a tool connector and a ratchet block, characterized in that the head portion has a tool connector cavity, and has a ratchet cavity adjacent to one side of the handle for communication with the tool connector, the ratchet block is positioned within the ratchet block cavity which can automatically move forward, the top face of the head portion corresponding to the top edge of the ratchet cavity is a notch for engaging with a covering plate, wherein the external edge of the tool connector is a series of ratchet teeth and the ratchet block is engageable with the tool connector, and the top face of the ratchet block is protruded with a trigger rod passed through the covering plate, and the center of the covering plate is a corresponding traverse trigger slot, thereby a ratchet wrench is obtained.

10. The ratchet wrench of claim 9, wherein the bottom edge of the tool connector cavity is a protruded urging circular plate for urging with the tool connector.

11. The ratchet wrench of claim 9, wherein the top face of the two sides of the notch is provided with a screw hole, and the covering plate is correspondingly provided with through hole and the covering plate is locked to the head portion with bolts.

12. The ratchet wrench of claim 9, wherein the tool connector is either a sleeve or protruded pillar type.

13. The ratchet wrench of claim 9, wherein the rear wall face of the ratchet block wall face is a cavity hole for a top peg and an elastic element, and the corresponding edge of the ratchet block is a position arch-edge for the positioning of the tool connector after the rotation thereof.

14. The ratchet wrench of claim 9, wherein the rear wall face of the ratchet cavity is a position arch edge, and the corresponding edge of the ratchet block is a cavity hole for the positioning of the top peg and the elastic element for the positioning of the tool connector after the rotation thereof.
